(19) United States
(12) Patent Application Publication
(10) Pub. No.: US 2025/0142387 A1
(43) Pub. Date: May 1, 2025

(54) FEEDBACK REPORT FOR SIDELINK COMMUNICATIONS USING CARRIER AGGREGATION

(71) Applicant: QUALCOMM INCORPORATED, San Diego, CA (US)

(72) Inventors: Shuanshuan Wu, San Diego, CA (US); Hui Guo, Beijing (CN); Anantharaman Balasubramanian, San Diego, CA (US); Kapil Gulati, Belle Mead, NJ (US)

(21) Appl. No.: 18/693,909

(22) PCT Filed: Nov. 11, 2021
(86) PCT No.: PCT/CN2021/129984

§ 371 Date: Mar. 20, 2024

(51) Int. Cl. H04W 24/10; H04W 72/21; H04W 72/25

(52) U.S. Cl. CPC H04W 24/10; H04W 72/21; H04W 72/25

(57) ABSTRACT

Methods, systems, and devices for wireless communication at a user equipment (UE) are described. A first user equipment (UE) may transmit one or more sidelink messages via multiple component carriers configured for sidelink communications for the first UE. The first UE may receive. from a second UE. one or more feedback messages associated with the one or more sidelink messages. The first UE may then transmit. to the base station, a feedback report that indicates feedback associated with at least one of the one or more sidelink messages. In some examples. the feedback report may be based on the one or more feedback messages received from the second UE.

### CROSS REFERENCE

The present Application is a 371 national stage filing of International PCT Application No. PCT/CN2021/129984 by Wu et al. entitled “FEEDBACK REPORT FOR SIDELINK COMMUNICATIONS USING CARRIER AGGREGATION,” filed Nov. 11, 2021, which is assigned to the assignee hereof, and which is expressly incorporated by reference in its entirety herein.

### FIELD OF TECHNOLOGY

The following relates to wireless communication at a user equipment (UE), including feedback report for sidelink communications using carrier aggregation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some examples, the UE may support sidelink carrier aggregation in which the UE may be capable of transmitting sidelink transmissions in more than one component carrier (CC) (e.g., more than one cell). Techniques for providing feedback in such systems may be deficient.

### SUMMARY

The described techniques relate to improved methods, systems, devices, and apparatuses that support feedback report for sidelink communications using carrier aggregation. Generally, the described techniques provide for a user equipment (UE) to determine a component carrier (CC) for transmitting sidelink feedback report. The UE, configured for multi-CC sidelink communication, may transmit sidelink transmissions via multiple CCs configured for sidelink communications. The UE may receive a set of sidelink feedback messages in response to the sidelink transmissions. The UE may then determine a CC to transmit a sidelink feedback report to a base station. In some examples, the UE may transmit the sidelink feedback report via a CC associated with a primary serving cell. Additionally or alternatively, the UE may determine the CC for transmitting a sidelink feedback report as the CC used to receive a downlink control information (DCI) scheduling the sidelink transmission.

A method for wireless communication at a first user equipment (UE) is described. The method may include transmitting one or more sidelink messages via multiple component carriers configured for sidelink communications for the first UE, receiving, from a second UE, one or more feedback messages associated with the one or more sidelink messages, and transmitting, to a base station, a feedback report that indicates feedback associated with at least one of the one or more sidelink messages, the feedback report based on the one or more feedback messages received from the second UE.

An apparatus for wireless communication at a first UE is described. The apparatus may include a processor, memory coupled with the processor, and instructions stored in the memory. The instructions may be executable by the processor to cause the apparatus to transmit one or more sidelink messages via multiple component carriers configured for sidelink communications for the first UE, receive, from a second UE, one or more feedback messages associated with the one or more sidelink messages, and transmit, to a base station, a feedback report that indicates feedback associated with at least one of the one or more sidelink messages, the feedback report based on the one or more feedback messages received from the second UE.

Another apparatus for wireless communication at a first UE is described. The apparatus may include means for transmitting one or more sidelink messages via multiple component carriers configured for sidelink communications for the first UE, means for receiving, from a second UE, one or more feedback messages associated with the one or more sidelink messages, and means for transmitting, to a base station, a feedback report that indicates feedback associated with at least one of the one or more sidelink messages, the feedback report based on the one or more feedback messages received from the second UE.

A non-transitory computer-readable medium storing code for wireless communication at a first UE is described. The code may include instructions executable by a processor to transmit one or more sidelink messages via multiple component carriers configured for sidelink communications for the first UE, receive, from a second UE, one or more feedback messages associated with the one or more sidelink messages, and transmit, to a base station, a feedback report that indicates feedback associated with at least one of the one or more sidelink messages, the feedback report based on the one or more feedback messages received from the second UE.

In some examples of the method, apparatuses, and non-transitory computer-readable medium described herein, transmitting the feedback report to the base station may include operations, features, means, or instructions for transmitting the feedback report via a component carrier associated with a primary serving cell configured for uplink communications for the first UE.

In some examples of the method, apparatuses, and non-transitory computer-readable medium described herein, transmitting the feedback report to the base station may include operations, features, means, or instructions for transmitting the feedback report via a component carrier associated with a primary serving cell configured for sidelink communications for the first UE, where the primary serving cell configured for sidelink communications may be different from a primary serving cell configured for uplink communications for the first UE.

Some examples of the method, apparatuses, and non-transitory computer-readable medium described herein may further include operations, features, means, or instructions for receiving, from the base station via a first component carrier, control information indicating a set of resources for transmitting the one or more sidelink messages, where transmitting the feedback report to the base station includes transmitting the feedback report via the first component carrier.

Some examples of the method, apparatuses, and non-transitory computer-readable medium described herein may further include operations, features, means, or instructions for receiving, from the base station via a set of component carriers of the multiple component carriers, control information indicating a set of resources for transmitting the one or more sidelink messages, where transmitting the feedback report to the base station includes transmitting the feedback report via the set of component carriers.

Some examples of the method, apparatuses, and non-transitory computer-readable medium described herein may further include operations, features, means, or instructions for transmitting the one or more sidelink messages includes transmitting the one or more sidelink messages via a first component carrier of the multiple component carriers and transmitting the feedback report to the base station includes transmitting the feedback report via the first component carrier.

Some examples of the method, apparatuses, and non-transitory computer-readable medium described herein may further include operations, features, means, or instructions for receiving the one or more feedback messages includes receiving the one or more feedback messages associated with each of the one or more sidelink messages via a respective second component carrier and transmitting the feedback report to the base station includes transmitting the feedback report via each of the respective second component carriers.

Some examples of the method, apparatuses, and non-transitory computer- readable medium described herein may further include operations, features, means, or instructions for receiving the one or more feedback messages includes receiving a first feedback message via a first second component carrier and a second feedback message via a second component carrier, where the second feedback message may be received later than the first feedback message and transmitting the feedback report to the base station includes transmitting the feedback report via the second component carrier.

Some examples of the method, apparatuses, and non-transitory computer-readable medium described herein may further include operations, features, means, or instructions for receiving, from the base station via a first component carrier, control information indicating a set of resources for an uplink transmission to the base station, where transmitting the feedback report to the base station includes transmitting the feedback report via the first component carrier.

Some examples of the method, apparatuses, and non-transitory computer-readable medium described herein may further include operations, features, means, or instructions for multiplexing the feedback report with the uplink transmission, where transmitting the feedback report to the base station includes transmitting the multiplexed feedback report and the uplink transmission.

In some examples of the method, apparatuses, and non-transitory computer-readable medium described herein, the set of resources for the uplink transmission includes physical uplink shared channel resources, physical uplink control channel resources, or both.

Some examples of the method, apparatuses, and non-transitory computer-readable medium described herein may further include operations, features, means, or instructions for receiving, from the base station, control information indicating a component carrier for transmitting the feedback report, where transmitting the feedback report to the base station includes transmitting the feedback report via the component carrier indicated in the control information.

In some examples of the method, apparatuses, and non-transitory computer-readable medium described herein, transmitting the feedback report to the base station may include operations, features, means, or instructions for transmitting, to the base station, the feedback report associated with a component carrier of the multiple component carriers via a respective uplink control information.

In some examples of the method, apparatuses, and non-transitory computer-readable medium described herein, transmitting the feedback report to the base station may include operations, features, means, or instructions for transmitting, to the base station, the feedback report associated with the multiple component carriers via an uplink control information.

Some examples of the method, apparatuses, and non-transitory computer-readable medium described herein may further include operations, features, means, or instructions for receiving, from the base station via a first component carrier, control information indicating a set of resources for the one or more sidelink messages transmitted via the multiple component carriers, where transmitting the one or more sidelink messages may be based on receiving the control information.

Some examples of the method, apparatuses, and non-transitory computer-readable medium described herein may further include operations, features, means, or instructions for transmitting, to the base station, a request for resources for sidelink communications, where receiving the control information may be based on transmitting the request.

In some examples of the method, apparatuses, and non-transitory computer-readable medium described herein, the multiple component carriers may be associated with a sidelink carrier aggregation communication scheme.

A method is described. The method may include receiving, from a UE, a request for resources for one or more sidelink messages to be transmitted by the UE via multiple component carriers, transmitting, to the UE and in response to the request, control information indicating a set of resources for the one or more sidelink messages to be transmitted by the UE via the multiple component carriers, and receiving, from the UE, a feedback report that indicates feedback associated with at least one of the one or more sidelink messages transmitted by the UE.

An apparatus is described. The apparatus may include a processor, memory coupled with the processor, and instructions stored in the memory. The instructions may be executable by the processor to cause the apparatus to receive, from a UE, a request for resources for one or more sidelink messages to be transmitted by the UE via multiple component carriers, transmit, to the UE and in response to the request, control information indicating a set of resources for the one or more sidelink messages to be transmitted by the UE via the multiple component carriers, and receive, from the UE, a feedback report that indicates feedback associated with at least one of the one or more sidelink messages transmitted by the UE.

Another apparatus is described. The apparatus may include means for receiving, from a UE, a request for resources for one or more sidelink messages to be transmitted by the UE via multiple component carriers, means for transmitting, to the UE and in response to the request, control information indicating a set of resources for the one or more sidelink messages to be transmitted by the UE via the multiple component carriers, and means for receiving, from the UE, a feedback report that indicates feedback associated with at least one of the one or more sidelink messages transmitted by the UE.

A non-transitory computer-readable medium storing code is described. The code may include instructions executable by a processor to receive, from a UE, a request for resources for one or more sidelink messages to be transmitted by the UE via multiple component carriers, transmit, to the UE and in response to the request, control information indicating a set of resources for the one or more sidelink messages to be transmitted by the UE via the multiple component carriers, and receive, from the UE, a feedback report that indicates feedback associated with at least one of the one or more sidelink messages transmitted by the UE.

In some examples of the method, apparatuses, and non-transitory computer-readable medium described herein, receiving the feedback report from the UE may include operations, features, means, or instructions for receiving the feedback report via a component carrier associated with a primary serving cell configured for uplink communications for the UE.

In some examples of the method, apparatuses, and non-transitory computer-readable medium described herein, receiving the feedback report from the UE may include operations, features, means, or instructions for receiving the feedback report via a component carrier associated with a primary serving cell configured for sidelink communications for the UE, where the primary serving cell configured for sidelink communications may be different from a primary serving cell configured for uplink communications for the UE.

Some examples of the method, apparatuses, and non-transitory computer-readable medium described herein may further include operations, features, means, or instructions for transmitting the control information includes transmitting, via a first component carrier, the control information indicating the set of resources for the one or more sidelink messages and receiving the feedback report from the UE includes receiving the feedback report via the first component carrier.

Some examples of the method, apparatuses, and non-transitory computer-readable medium described herein may further include operations, features, means, or instructions for transmitting the control information includes transmitting, via a set of component carriers of the multiple component carriers, the control information indicating the set of resources for the one or more sidelink messages and receiving the feedback report from the UE includes receiving the feedback report via the set of component carriers.

In some examples of the method, apparatuses, and non-transitory computer-readable medium described herein, receiving the feedback report from the UE may include operations, features, means, or instructions for receiving the feedback report via a first component carrier of the multiple component carriers, where the one or more sidelink messages may be to be transmitted via the first component carrier.

In some examples of the method, apparatuses, and non-transitory computer-readable medium described herein, receiving the feedback report from the UE may include operations, features, means, or instructions for receiving the feedback report via a respective component carrier associated with each of the one or more sidelink messages.

Some examples of the method, apparatuses, and non-transitory computer-readable medium described herein may further include operations, features, means, or instructions for transmitting the control information includes transmitting, via a first component carrier, the control information indicating the set of resources for an uplink transmission to the base station and receiving the feedback report from the UE includes receiving the feedback report via the first component carrier.

In some examples of the method, apparatuses, and non-transitory computer-readable medium described herein, the set of resources for the uplink transmission includes physical uplink shared channel resources, physical uplink control channel resources, or both.

In some examples of the method, apparatuses, and non-transitory computer-readable medium described herein, transmitting the control information may include operations, features, means, or instructions for transmitting the control information indicating a component carrier for transmitting the feedback report, where receiving the feedback report includes receiving the feedback report via the component carrier indicated in the control information.

In some examples of the method, apparatuses, and non-transitory computer-readable medium described herein, receiving the feedback report from the UE may include operations, features, means, or instructions for receiving, via a respective uplink control information, the feedback report associated with a component carrier of the multiple component carriers.

### BRIEF DESCRIPTION OF THE DRAWINGS

FIG. 1 illustrates an example of a wireless communications system that

supports feedback report for sidelink communications using carrier aggregation in accordance with aspects of the present disclosure.

FIG. 2 illustrates an example of a wireless communications system that supports feedback report for sidelink communications using carrier aggregation in accordance with aspects of the present disclosure.

FIG. 3 illustrates an example of a wireless communications system that supports feedback report for sidelink communications using carrier aggregation in accordance with aspects of the present disclosure.

FIG. 4 illustrates an example of a wireless communications system that supports feedback report for sidelink communications using carrier aggregation in accordance with aspects of the present disclosure.

FIG. 5 illustrates an example of a process flow that supports feedback report for sidelink communications using carrier aggregation in accordance with aspects of the present disclosure.

FIGS. 6 and 7 show block diagrams of devices that support feedback report for sidelink communications using carrier aggregation in accordance with aspects of the present disclosure.

FIG. 8 shows a block diagram of a communications manager that supports feedback report for sidelink communications using carrier aggregation in accordance with aspects of the present disclosure.

FIG. 9 shows a diagram of a system including a device that supports feedback report for sidelink communications using carrier aggregation in accordance with aspects of the present disclosure.

FIGS. 10 and 11 show block diagrams of devices that support feedback report for sidelink communications using carrier aggregation in accordance with aspects of the present disclosure.

FIG. 12 shows a block diagram of a communications manager that supports feedback report for sidelink communications using carrier aggregation in accordance with aspects of the present disclosure.

FIG. 13 shows a diagram of a system including a device that supports feedback report for sidelink communications using carrier aggregation in accordance with aspects of the present disclosure.

FIGS. 14 through 17 show flowcharts illustrating methods that support feedback report for sidelink communications using carrier aggregation in accordance with aspects of the present disclosure.

### DETAILED DESCRIPTION

A wireless communications system may support both access links and sidelinks for communications between one or more communication devices. An access link may refer to a communication link between a user equipment (UE) and a base station. For example, an access link may support uplink signaling, downlink signaling, connection procedures, etc. A sidelink may refer to any communication link between similar wireless devices (e.g., a communication link between UEs, or a backhaul communication link between base stations). Sidelink communications may support communications within a group of UEs. For example, sidelink communications may include communications between a UE and one or more other UEs within a coverage area. In some examples, sidelink communication may support two modes of resource allocation mechanism. In a first mode of operation (e.g., Mode 1), resources may be scheduled by a base station. In a second mode of operation (e.g., Mode 2), base stations may not be involved in sidelink communications and a UE may perform autonomous resource selection.

Some wireless communications systems may support hybrid automatic request (HARQ) feedback-based transmissions in sidelink. For example, a first UE participating in sidelink communications may transmit a scheduling request (SR) and a sidelink buffer status report (SL BSR) to a base station for sidelink scheduling. In Mode 1, a base station may transmit a control message (e.g., downlink control information (DCI)) granting one or multiple resources (e.g., time or frequency resources) for sidelink communications between the first UE and a second UE. The first UE may transmit a sidelink transmission to the second UE using the granted resources. The second UE may transmit HARQ feedback (e.g., acknowledgement (ACK)/negative acknowledgment (NACK)) to the first UE in response to receiving the sidelink transmission. In some cases, the first UE may report the sidelink HARQ feedback received from the second UE to the base station in a sidelink feedback report (e.g., in physical uplink control channel (PUCCH) or physical uplink shared channel (PUSCH)). The first UE may communicate using a primary cell on a first carrier as well as one or more secondary cells on other carriers in the wireless communications system which supports carrier aggregation. In some cases, the first UE may support sidelink carrier aggregation and may be scheduled to transmit sidelink transmissions to one or more UEs in more than one component carrier (CC) (e.g., using more than one cell). Therefore, the first UE may receive HARQ feedback for each sidelink transmission on multiple carriers. In such cases, the first UE may be unable to determine a CC to transmit the sidelink feedback report to the base station for the HARQ feedbacks received from the one or more UEs.

In accordance with the techniques described herein, a first UE, configured for multi-CC sidelink communication, may transmit sidelink messages via multiple CCs configured for sidelink communications. The first UE may then determine a CC to transmit a sidelink feedback (e.g., HARQ) report to a base station. In some cases, the sidelink feedback report may be transmitted via a CC associated with a primary serving cell. In some cases, the primary serving cell may be the primary serving cell for uplink communication Additionally or alternatively, the primary serving cell may be the primary serving cell for sidelink communications which, in some cases, may be the different than the primary serving cell for uplink communications. In some cases, the CC for transmitting a sidelink feedback report may be the CC used to receive a DCI scheduling the sidelink transmission corresponding to the sidelink feedback report. Further, the first UE may transmit one or more sidelink feedback reports via an uplink control information (UCI). In some instances, sidelink feedback for multiple CCs may be carried in one UCI. In such cases, the sidelink feedback report may be generated in a cell first time second order or in a time first order.

UEs configured for multi-CC sidelink communication supporting signaling for transmitting a sidelink feedback report in sidelink communications systems may utilize the techniques described herein to experience power savings and extended battery life while ensuring reliable and efficient communications. Particular aspects of the subject matter described in this disclosure may be implemented to support high reliability and low latency communications, among other examples. The described techniques for determining a CC for transmitting a sidelink feedback report to a base station include features for improvements to power consumption, spectral efficiency, higher data rates and, in some examples, may promote efficiency for high reliability and low latency operations, among other benefits.

Aspects of the disclosure are initially described in the context of wireless communications systems. Aspects of the disclosure are further described in the context of a process flow. Aspects of the disclosure are further illustrated by and described with reference to apparatus diagrams, system diagrams, and flowcharts that relate to feedback report for sidelink communications using carrier aggregation.

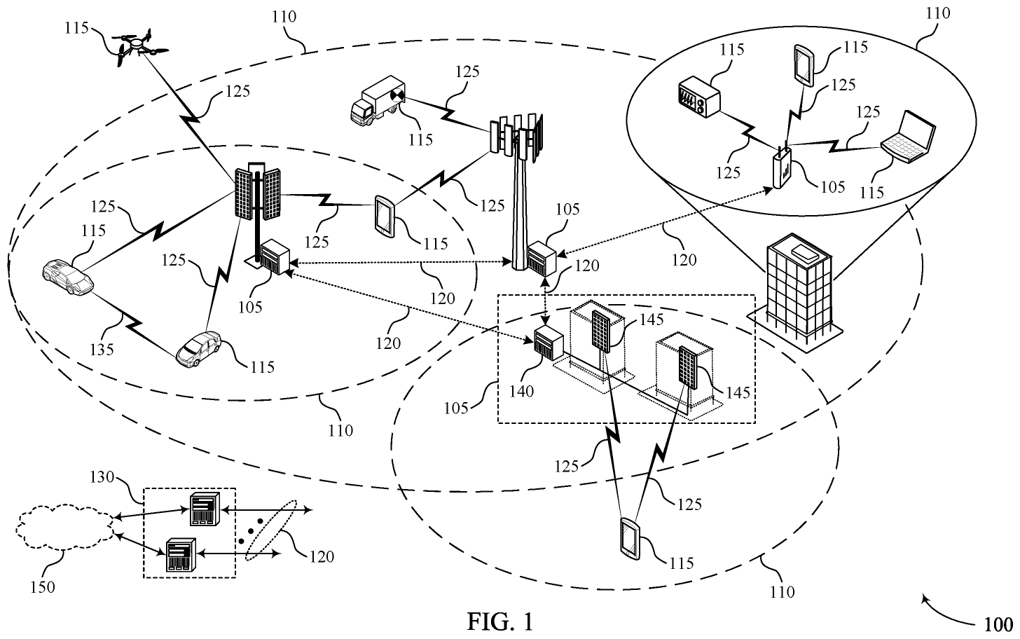

FIG. 1 illustrates an example of a wireless communications system 100 that supports feedback report for sidelink communications using carrier aggregation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D₂D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with CCs operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Some wireless communications systems may support HARQ feedback-based transmissions in sidelink or V2X communications. For example, in Mode 1, a first UE 115 participating in sidelink communications may transmit an SR and a SL BSR to a base station for sidelink scheduling. The base station 105 may send DCI granting one or multiple resources for the first UE for sidelink transmissions (e.g., DCI format 3_0 for dynamic grant scheduling). The control information may indicate time or frequency resources for the sidelink transmissions. The first UE 115 may transmit one or more sidelink messages (e.g., sidelink control and data) to a second UE using the granted resources. In Mode 2, the first UE 115 may perform resource allocation for one or more sidelink message transmissions from the first UE 115 to the second UE 115.

In some cases, the first UE 115 may transmit one or more sidelink messages (e.g., physical sidelink control channel (PSCCH) or physical sidelink shared channel (PSSCH)) to the second UE 115. Additionally, or alternatively, the first UE 115 may receive HARQ feedback (e.g., ACK/NACK) for the one or more sidelink messages. In some cases, the second UE 115 may transmit HARQ feedback (e.g., using a physical sidelink feedback channel (PSFCH)) to the first UE 115 upon receiving one or more sidelink messages.

In Mode 1, the first UE 115 may transmit the HARQ feedback (e.g., the feedback received from the second UE 115) to the base station 105 in a feedback report (or sidelink feedback report). In some cases (e.g., with sidelink carrier aggregation), the first UE 115 may be scheduled to transmit in more than one CC (e.g., more than one cell such as a primary cell and at least one or more secondary cells). Therefore, the first UE 115 may receive HARQ feedback for multiple sidelink transmissions in multiple carriers. In Mode 1, the first UE 115 may report the feedback report for the sidelink transmissions to the base station 105 based on the HARQ feedback received from the sidelink transmissions in the multiple carriers. However, some feedback report mechanisms may not be sufficient when carrier aggregation is configured. Further, some feedback report mechanisms may be unable to support different sidelink carrier aggregation implementations (e.g., sidelink Mode 1 with and without cross carrier scheduling).

In accordance with the techniques described herein, a first UE 115, configured for multi-CC sidelink communication, may transmit sidelink messages via multiple CCs configured for sidelink communications. The first UE 115 may then determine a CC to transmit a sidelink feedback (e.g., HARQ) report to a base station 105. In some cases, the sidelink feedback report may be transmitted via a CC associated with the primary serving cell. In some cases, the CC for transmitting a sidelink feedback report may be the CC in which the sidelink transmission corresponding to the sidelink feedback report is scheduled. In some cases, the CC for transmitting a sidelink feedback report may be the CC in which the sidelink feedback message corresponding to the sidelink feedback report is received.

Additionally or alternatively, if the first UE 115 receives multiple sidelink feedback messages via multiple CCs within a sidelink feedback window, the CC for transmitting a sidelink feedback report may be the CC in which the last sidelink feedback report is received in a sidelink feedback window. In some cases, the CC for transmitting a sidelink feedback report may be the CC in which the first UE 115 has resources granted for an uplink transmission (e.g., physical uplink shared channel (PUSCH) resources). That is, the sidelink feedback report may be transmitted to the base station 105 with an uplink transmission. In some cases, the CC for transmitting a sidelink feedback report may be the CC in which the first UE 115 has resources granted for an uplink feedback transmission (e.g., PUCCH resources). In some cases, the CC for transmitting a sidelink feedback report may be indicated in DCI scheduling the sidelink transmission corresponding to the sidelink feedback report.

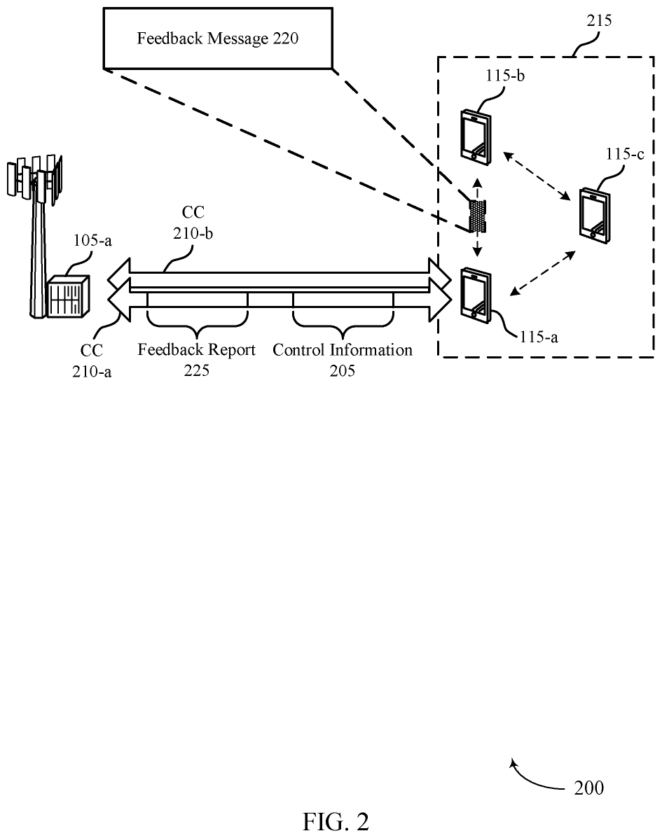

FIG. 2 illustrates an example of a wireless communications system 200 that supports feedback report for sidelink communications using carrier aggregation in accordance with aspects of the present disclosure. In some examples, the wireless communications system 200 may implement aspects of wireless communications system 100. The wireless communications system 200 includes a base station 105-a and one or more UEs 115 (which may also be referred to as devices).

In some examples, the wireless communications system 200 may utilize control signaling to schedule resources for the UEs 115 to perform sidelink communications. Additionally or alternatively, the UEs 115 in the wireless communications system 200 may utilize shared information to enhance scheduling, inter-UE coordination, and communications flexibility. In some examples, the group of UEs 115 (for example, UE 115-a (UE 1), UE 115-b (UE 2), and UE 115-c (UE 3)) may communicate with each other (for example, within a vehicle-to-everything (V2X) system, a device-to-device (D2D) system, among other examples) and may employ sidelink transmissions to save power, reduce latency, and ensure reliable communications. In some examples, vehicles may communicate using V2X resource allocation mode 2 (that utilizes UE autonomous resource selection).

The wireless communications system 200 may support both access links and sidelinks for communications between one or more communication devices. An access link may refer to a communication link between a UE 115 (such as, UE 115-a, UE 115-b and UE 115-c) and a base station 105-a. A sidelink may refer to any communication link between similar wireless devices (for example, a communication link between UEs, or a backhaul communication link between base stations). It is noted that while various examples provided herein are discussed for UE sidelink devices, such sidelink techniques may be used for any type of wireless devices that use sidelink communications. For example, a sidelink may support one or more of D2D communications, V2X or vehicle-to-vehicle (V2V) communications, message relaying, discovery signaling, beacon signaling, or other signals transmitted over-the-air from one UE to one or more other UEs.

The base station 105-a may communicate with one or more UEs 115 (for example, UEs 115-a, UE 115-b, and UE 115-c), which may be included within a UE group 215. For example, the base station 105-a may transmit a control signal to the UE 115-a (UE 1), the UE 115-b (UE 2), or the UE 115-c (UE 3). As depicted in the example of FIG. 2, the UE 115-a, the UE 115-b, and the UE 115-c may communicate with each other (or with another group of UEs 115) over sidelink communications (for example, using a peer-to-peer (P2P) or D2D protocol). In some examples, the UE 115-a may transmit sidelink transmissions to the UE 115-b or the UE 115-c. In some examples, the UE 115-a or the UE 115-b may monitor resource pools for the sidelink communications or indications of the sidelink communications (for example, resource reservations, control channel transmissions, among other examples) from other UEs 115 in the group. Additionally or alternatively, the UEs 115 may have data to transmit to (or receive from) a UE 115 in the UE group and may use the sidelink communications to transmit the data transmission. In some examples, the UE group 215 of the UEs 115 may utilize sidelinks communications in addition to access links with the base station 105-a.

As depicted herein, the wireless communications systems 200 may support resource allocation and HARQ feedback-based transmissions in sidelink. For example, in some cases, a UE 115-a may transmit an SR and SL BSR to the base station 105-a for sidelink scheduling. The sidelink buffer status may indicate an amount of data available for transmission. The base station may transmit control information 205 (e.g., DCI) granting one or multiple resources (e.g., time or frequency resources) for the sidelink transmission between the UE 115-a (e.g., first UE) and the UE 115-b (e.g., second UE) based on the request (e.g., DCI format 3_0 for dynamic grant scheduling). In some other cases, the UE 115-a may determine the resources for the sidelink transmission. The UE 115-a may transmit the sidelink transmission (e.g., PSCCH or PSSCH) to the UE 115-b in the granted or determined resources. The UE 115-b may transmit HARQ feedback (e.g., ACK or NACK) to the UE 115-a in response to receiving the sidelink transmission. In some cases, the UE 115-a may report the feedback message 220 received from the UE 115-b to the base station 105-a in the feedback report 225 (e.g., in PUCCH or PUSCH). The UE 115-a may support sidelink carrier aggregation and may be scheduled to transmit sidelink transmissions to one or more UEs in more than one CC (e.g., more than one cell).

Aspects depicted herein provide for the UE 115-a may determine a CC to transmit the feedback report 225 to the base station 105-a for the feedback messages 220 received from the one or more UEs 115. As an illustrative example, a base station 105-a may transmit control information 205 to a UE 115-a on CC 210-a granting the UE 115-a resources for one or more sidelink transmissions. The UE 115-a may use the granted resources to communicate sidelink messages to a UE 115-b and a UE 115-c in a UE group 215. In some cases, the UE 115-b may transmit a feedback message 220 to the UE 115-a in response to the one or more sidelink messages. There are multiple carriers available for the UE 115-a to transmit the feedback report 225 to the base station 105-a, such as CC 210-a and CC 210-b.

In accordance with the techniques described herein, a first device (e.g., the UE 115-a), configured for multi-CC sidelink communication, may determine a CC to transmit a sidelink feedback (e.g., HARQ) report to a second device (e.g., the base station 105-a). In some cases, the CC for feedback reports 225 may be the primary serving cell. That is, the UE 115-a may transmit a feedback report 225 to the base station 105-a via a CC associated with a primary serving cell configured for uplink transmissions for the UE 115-a. In some cases, the primary cell may be the primary serving cell of the UE 115-a for uplink communications. Additionally or alternatively, the primary serving cell may be the primary serving cell for sidelink communications, which may be configured by the base station 105-a. In some cases, the primary cell for sidelink communications may be the same as the primary cell for uplink communications, while in other cases it may be different. For example, the UE 115-a and the base station 105-a may be configured for multi-CC communications, therefore, CC 210-a and CC 210-b may be available for transmissions from the UE 115-a. In some examples, CC 210-a may be associated with the primary serving cell configured for uplink transmissions.

In some cases, the UE 115-a may transmit a control message to the base station 105-a requesting resources for one or more sidelink transmissions in UE group 215 and the base station 105-a may transmit control information 205 to the UE 115-a granting resources based on the request. In some cases, the UE 115-a may determine the resources to use for the one or more sidelink transmissions. As depicted herein, The UE 115-b may transmit feedback message 220 to the UE 115-a based on the one or more sidelink messages. The UE 115-a may transmit feedback report 225 to the base station 105-a on CC 210-a, which may be the primary serving cell for uplink transmissions.

In some cases, the CC for transmitting the feedback report 225 may be the CC that the base station 105-a granted to the UE 115-a for uplink transmissions (e.g., granted by the PUSCH resource). That is, the UE 115-a may transmit the feedback report 225 with an uplink transmission (e.g., multiplexed with the PUSCH transmission). For example, a base station 105-a may transmit control information 205 to a UE 115-a granting CC 210-a for PUSCH transmissions. Therefore, the UE 115-a may transmit the feedback report 225, based on the feedback message 220 from the UE 115-b, to the base station 105-a in CC 210-a. In some examples, the base station 105-a may transmit control information 205 to the UE 115-a indicating whether the feedback report 225 is to be transmitted in a PUSCH or is to be transmitted via a fall back method. Additionally or alternatively, the UE 115-a may determine to transmit a feedback report 225 in PUSCH based on whether PUCCH resources for the feedback report 225 are configured by the base station 105-a. Additionally or alternatively, if PUSCH resources are granted (e.g., in the same slot as PUCCH resources configured for feedback reports), then the UE 115-a may transmit the feedback report 225 in PUSCH.

In some cases, the CC for transmitting the feedback report 225 may be the CC that the base station 105-a granted to the UE 115-a for uplink feedback transmissions (e.g., the CC may be the resources granted for PUCCH). That is, the UE 115-a may transmit the feedback report 225 in an UCI (e.g., multiplexed with UCI). For example, the base station 105-a may transmit control information 205 to the UE 115-a granting CC 210-b for PUCCH transmissions. Therefore, the UE 115-a may transmit the feedback report 225, based on the feedback message 220 from the UE 115-b, to the base station 105-a in CC 210-b.

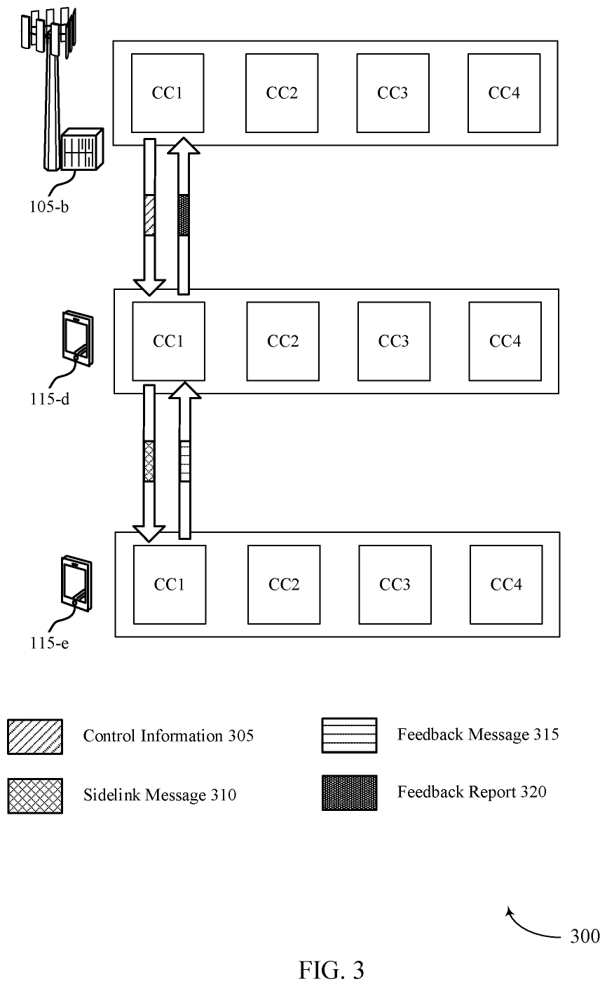

In some cases, the CC for feedback report 225 transmission may be the CC in which the UE 115-a receives control information 205 (e.g., DCI) scheduling the sidelink transmissions. In some other cases, the CC for the feedback report 225 transmission may be the same CC in which PSCCH or PSSCH is scheduled. Additionally or alternatively, the CC for the feedback report 225 transmission may be indicated in the DCI scheduling the sidelink transmission. These methods are further described with respect to FIG. 3.

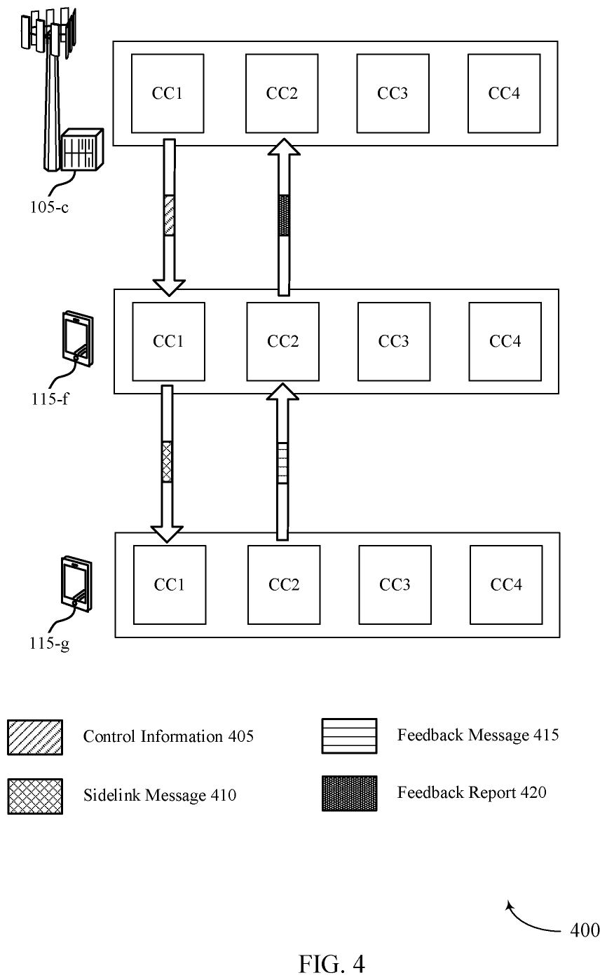

Additionally or alternatively, the CC for the feedback report 225 transmissions may be the CC in which the UE 115-a last received a feedback report 225 in a PSFCH in a sidelink feedback report window. These methods are further described with respect to FIG. 4.

In some cases, the UE 115-a may receive multiple feedback messages 220 for multiple sidelink transmission in multiple CCs. Additionally or alternatively, each CC may have multiple sidelink transmissions (e.g., transport block transmissions). Therefore, the UE 115-a may generate a sidelink feedback report codebook. In some cases, sidelink feedback for each CC may be transmitted to the base station 105-a in a UCI. That is, the UE 115-a may transmit multiple PUCCHs in the same or multiple CCs if the sidelink transmissions have been scheduled in multiple CCs. In some cases, sidelink feedback received for all CCs may be transmitted to the base station 105-a in a UCI. That is, the UE 115-a may generate a sidelink feedback report codebook and may include sidelink feedback for sidelink transmissions in all CCs. In some cases, the codebook may be generated in cell first, time second order. In some other cases, the codebook may be generated in time first order. In such cases, if multiple sidelink transmissions are scheduled at the same time (e.g., in the same slot), the UE 115-a may map a sidelink feedback bit based on the CC index.

Though the examples depicted herein describe two CCs, it is to be understood that the base station 105-a and the UEs 115 may be configured for more than two CCs.

FIG. 3 illustrates an example of a wireless communications system 300 that supports feedback report for sidelink communications using carrier aggregation in accordance with aspects of the present disclosure. In some examples, the wireless communications system 300 may implement aspects of wireless communications system 100 and wireless communications system 200. The wireless communications system 300 includes a base station 105-b and one or more UEs 115 (which may also be referred to as devices) which may be examples of base station 105 and UE 115 described with reference to FIGS. 1 and 2.

One or more aspects of the present disclosure provide for a UE 115-d determining one or more CCs (e.g., one or more cells) for transmitting a sidelink feedback report to a base station 105-b. In some cases, the UE 115-d may select a CC to transmit a feedback message 315 based on the CC in which the UE 115-d receives control information 305 (e.g., DCI) scheduling one or more sidelink messages 310. In some cases, a base station 105-b may transmit the control information 305 in a first CC (CC1), and the UE 115-d may transmit a feedback report 320 (e.g., sidelink feedback report) for the one or more sidelink messages 310 in the same CC. For example, the base station 105-b may transmit the control information 305 scheduling a sidelink message 310 for the UE 115-d in CC1. The UE 115-d may transmit the sidelink message 310 to a UE 115-e according to the scheduling information transmitted in the control information 305. In response to the sidelink message 310, the UE 115-e may transmit a feedback message 315 to the UE 115-d. In some examples, the UE 115-d may transmit a feedback report 320 in CCI based on a feedback message 315.

In some cases, the base station 105-b may transmit control information 305 scheduling one or more sidelink messages 310 in more than one cells. Therefore, the UE 115-d may transmit the feedback report 320 for the one or more sidelink messages 310 in a corresponding CC. If the UE 115-d receives the control information 305 scheduling the one or more sidelink messages 310 in the first CC (CC1), the UE 115-d may transmit the feedback report 320 for the one or more sidelink messages 310 in the second CC (CC2) based on a CC pair configured for the UE 115-d.

In some cases, the UE 115-d may select a CC to transmit a feedback message 315 based on the CC in which the UE 115-d is scheduled to transmit one or more sidelink messages 310. For example, the base station 105-b may transmit the control information 305 to a UE 115-d scheduling a sidelink message 310 in CC1. The UE 115-d may transmit the sidelink message 310 to a UE 115-e as scheduled and receive a feedback message 315 from the UE 115-e based on the sidelink message 310. The UE 115-d may transmit a feedback report 320 for the feedback message 315 to the base station 105-b in CC1. Though the example described herein depicts the sidelink message 310 scheduled and transmitted in the same CC that the control information 305 is received, it is understood that the sidelink message 310 may be scheduled in a CC different than the one the control information 305 is received in (e.g., cross carrier scheduling for sidelink is enabled).

In some examples, the UE 115-d may select a CC to transmit the feedback message 315 based on the CC indicated in control information 305 scheduling one or more sidelink messages 310. In some cases, a field in the control information 305 may indicate the CC for one or more feedback report 320 transmissions (e.g., similar to a field carrier indicator for cross carrier scheduling). For example, the base station 105-b may transmit the control information 305 to the UE 115-d, where the control information 305 may schedule the sidelink message 310 and may indicate CC1 as the CC to be used for a feedback report 320 transmission. Therefore, the UE 115-d may transmit the sidelink message 310 to the UE 115-e based on the scheduling. The UE 115-d may receive the feedback message 315 from the UE 115-e based on the sidelink message 310. The UE 115-d may transmit the feedback report 320 on CC1 as indicated in the control information 305. Additionally or alternatively, a resource indicator (e.g., PUCCH resource indicator) in the control information 305 may indicate the CC to be used for a feedback report 320 transmission. For example, a radio resource control (RRC) message may configure multiple PUCCH resources and each PUCCH resource may have an associated CC. Therefore, the control information 305 may indicate the PUCCH resource to be used (e.g., using a PUCCH resource indicator) and the CC associated with the indicated PUCCH resource may be the CC selected for transmission of the feedback report 320

FIG. 4 illustrates an example of a wireless communications system 400 that supports feedback report for sidelink communications using carrier aggregation in accordance with aspects of the present disclosure. In some examples, the wireless communications system 400 may implement aspects of wireless communications system 100, wireless communications system 200, and wireless communications system 300. The wireless communications system 400 includes a base station 105-c and one or more UEs 115 (which may also be referred to as devices) which may be examples of base station 105 and UE 115 described with reference to FIGS. 1 and 2.

In some cases (e.g., cross-carrier sidelink feedback reporting), a UE 115-f may select a CC to transmit a feedback message 415 based on the CC in which the UE 115-f may receive a feedback message 415 for a sidelink message 310 (e.g., SL PSFCH). That is, the UE 115-f may transmit the feedback report 420 via the same CC that the UE 115-f receives feedback message 415 from a UE 115-g. For example, the UE 115-f may receive control information 405 from a base station 105-c scheduling the sidelink message 410. The UE 115-f may transmit the sidelink message 410 to the UE 115-g based on the scheduling. The UE 115-g may transmit the feedback message 415 to the UE 115-f on CC2 based on the sidelink message 410. Therefore, the UE 115-f may transmit the feedback report 420 to the base station 105-c on CC2.

In some cases (e.g., cross-carrier sidelink feedback reporting), the UE 115-fmay select a CC to transmit a feedback message 415 based on the CC in which the UE 115-f receives a most recent feedback message 415 (e.g., SL PSFCH). That is, the UE 115-f may receive a feedback message 415 from one or more UEs 115 on one or more CCs in a given time period. The UE 115-g may transmit the last feedback message 415 to the UE 115-f in CC2 during the given time period. Therefore, the UE 115-f may transmit the feedback report 420 to the base station 105-c in CC2.

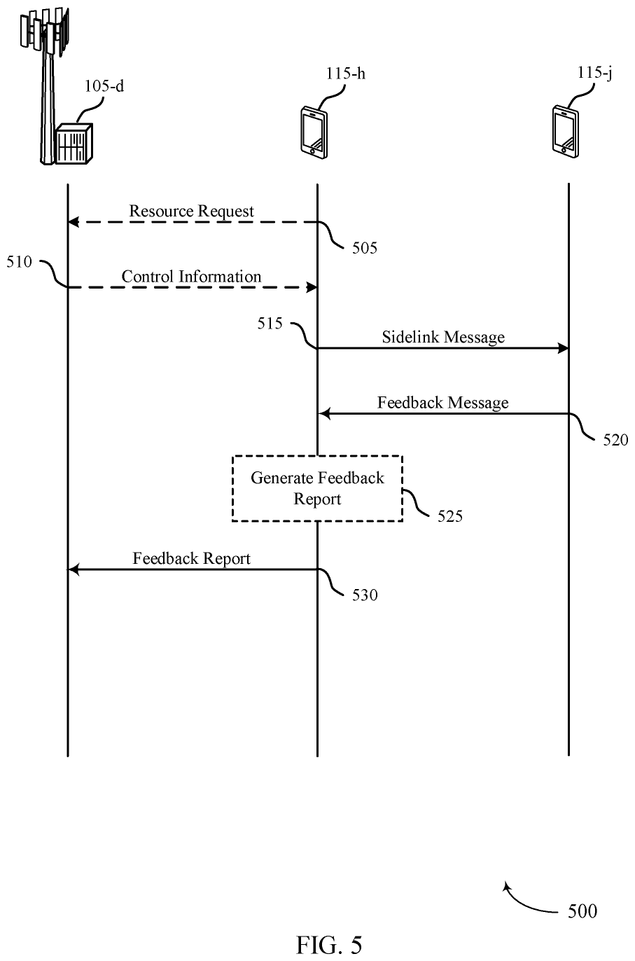

FIG. 5 illustrates an example of a process flow 500 that supports feedback report for sidelink communications using carrier aggregation in accordance with aspects of the present disclosure. In some examples, the process flow 500 may implement aspects of wireless communications system 100 and the wireless communications system 200 described with reference to FIGS. 1 and 2, respectively. For example, the process flow 500 may be implemented by a base station 105-d, a UE 115-h and a UE 115-j, for reduced power consumption, improved efficiency, and may promote low latency for wireless communications, among other benefits. The base station 105-d, the UE 115-h and the UE 115-j may be examples of a base station 105 and a UE 115, as described with reference to FIGS. 1 through 4.

In the following description of the process flow 500, the operations between the base station 105-d, the UE 115-h and the UE 115-j may be transmitted in a different order than the example order shown, or the operations performed by the base station 105-d, the UE 115-h and the UE 115-j may be performed in different orders or at different times. Some operations may also be omitted from the process flow 500, and other operations may be added to the process flow 500.

At 505, a UE 115-h may optionally transmit a request to a base station 105-d for resources for sidelink communications via multiple CCs. At 510, in response to the request at 505, the base station 105-d may optionally transmit control information to the UE 115-h via a first CC.

In some examples, the control information may indicate a set of resources for transmitting sidelink messages. In some cases, the control information may indicate a CC for transmitting the feedback report. In some cases, the base station 105-d may transmit control information via a set of CCs and the control information may indicate a set of resources for transmitting one or more sidelink messages. In some cases, the control information may indicate a set of resources for an uplink transmission to the base station 105-d. The set of resources for the uplink transmission may include PUSCH, PUCCH, or both.

At 515, the UE 115-h may transmit one or more sidelink messages to a UE 115-j via multiple components carriers configured for sidelink communications. In some cases, the UE 115-h may transmit one or more sidelink messages via a first CC. As depicted herein, multiple CCs may be associated with a sidelink carrier aggregation communication scheme.

At 520, the UE 115-h may receive, from the UE 115-j, one or more feedback messages associated with the one or more sidelink messages. In some cases, the UE 115-h may receive the one or more feedback messages via a second CC. In some cases, the UE 115-h may receive a first feedback message via a first CC and a second feedback message via a second CC. At 525, the UE 115-h may generate a feedback report based on one or more feedback messages received from the UE 115-j at 520.

At 530, the UE 115-h may transmit a feedback report indicating feedback associated with at least one of the sidelink messages and based on the one or more feedback reports received from the UE 115-j at 520. In some cases, the UE 115-h may transmit the feedback report via a CC associated with a primary serving cell configured for uplink communications.

In some cases, the UE 115-h may transmit the feedback report via a CC associated with a primary serving cell configured for the sidelink communications for UE 115-h, where the primary serving cell configured for sidelink communications is different than the one configured for uplink communications. In some cases, the UE 115-h may transmit the feedback report via the first CC used to receive control information from the base station 105-d at 510. In some cases, the UE 115-h may transmit the feedback report via the CC indicated in the control information received at 510.

In some cases, the UE 115-h may transmit the feedback report via the set of CCs used to transmit control information at 510. In some cases, the UE 115-h may transmit the feedback report via the first CC used to transmit one or more sidelink messages at 515. In some cases, the UE 115-h may transmit the feedback report via the second CC used to receive one or more feedback reports at 520. In some cases, the UE 115-h may multiplex the feedback report with an uplink transmission and transmit the uplink transmission via the resources indicated at 510.

In some cases, the feedback report associated with a CC of multiple CCs may be transmitted via a respective uplink control information. In some cases, the feedback report associated with multiple CCs may be transmitted via a respective uplink control information.

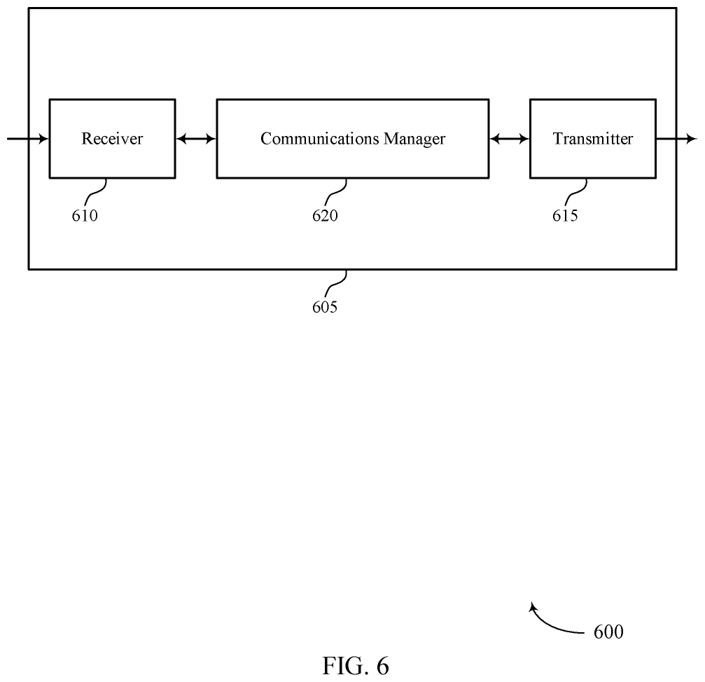

FIG. 6 shows a block diagram 600 of a device 605 that supports feedback report for sidelink communications using carrier aggregation in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to feedback report for sidelink communications using carrier aggregation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to feedback report for sidelink communications using carrier aggregation). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of feedback report for sidelink communications using carrier aggregation as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a first UE in accordance with examples as disclosed herein. For example, the communications manager 620 may be configured as or otherwise support a means for transmitting one or more sidelink messages via multiple CCs configured for sidelink communications for the first UE. The communications manager 620 may be configured as or otherwise support a means for receiving, from a second UE, one or more feedback messages associated with the one or more sidelink messages. The communications manager 620 may be configured as or otherwise support a means for transmitting, to a base station, a feedback report that indicates feedback associated with at least one of the one or more sidelink messages, the feedback report based on the one or more feedback messages received from the second UE.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

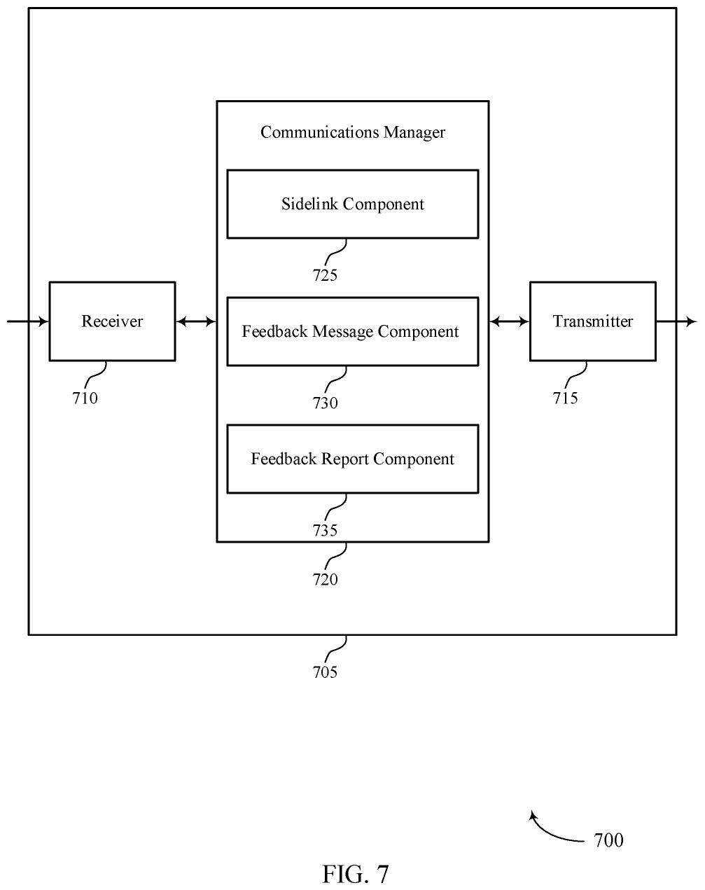

FIG. 7 shows a block diagram 700 of a device 705 that supports feedback report for sidelink communications using carrier aggregation in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to feedback report for sidelink communications using carrier aggregation). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to feedback report for sidelink communications using carrier aggregation). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of feedback report for sidelink communications using carrier aggregation as described herein. For example, the communications manager 720 may include a sidelink component 725, a feedback message component 730, a feedback report component 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a first UE in accordance with examples as disclosed herein. The sidelink component 725 may be configured as or otherwise support a means for transmitting one or more sidelink messages via multiple CCs configured for sidelink communications for the first UE. The feedback message component 730 may be configured as or otherwise support a means for receiving, from a second UE, one or more feedback messages associated with the one or more sidelink messages. The feedback report component 735 may be configured as or otherwise support a means for transmitting, to a base station, a feedback report that indicates feedback associated with at least one of the one or more sidelink messages, the feedback report based on the one or more feedback messages received from the second UE.

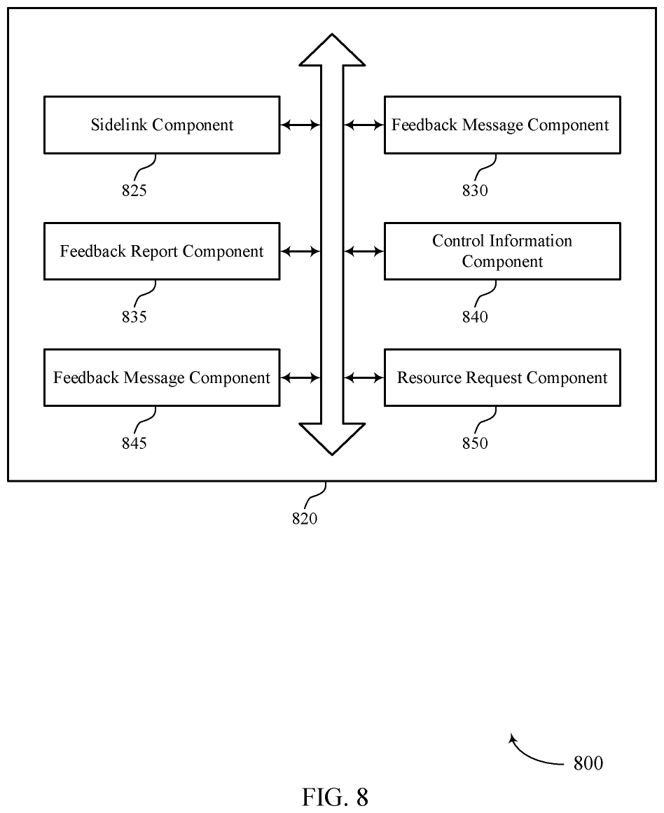

FIG. 8 shows a block diagram 800 of a communications manager 820 that supports feedback report for sidelink communications using carrier aggregation in accordance with aspects of the present disclosure. The communications manager 820 may be an example of aspects of a communications manager 620, a communications manager 720, or both, as described herein. The communications manager 820, or various components thereof, may be an example of means for performing various aspects of feedback report for sidelink communications using carrier aggregation as described herein. For example, the communications manager 820 may include a sidelink component 825, a feedback message component 830, a feedback report component 835, a control information component 840, a feedback message component 845, a resource request component 850, or any combination thereof. Each of these components may communicate, directly or indirectly, with one another (e.g., via one or more buses).

The communications manager 820 may support wireless communication at a first UE in accordance with examples as disclosed herein. The sidelink component 825 may be configured as or otherwise support a means for transmitting one or more sidelink messages via multiple CCs configured for sidelink communications for the first UE. The feedback message component 830 may be configured as or otherwise support a means for receiving, from a second UE, one or more feedback messages associated with the one or more sidelink messages. The feedback report component 835 may be configured as or otherwise support a means for transmitting, to a base station, a feedback report that indicates feedback associated with at least one of the one or more sidelink messages, the feedback report based on the one or more feedback messages received from the second UE.

In some examples, to support transmitting the feedback report to the base station, the feedback report component 835 may be configured as or otherwise support a means for transmitting the feedback report via a CC associated with a primary serving cell configured for uplink communications for the first UE.

In some examples, to support transmitting the feedback report to the base station, the feedback report component 835 may be configured as or otherwise support a means for transmitting the feedback report via a CC associated with a primary serving cell configured for sidelink communications for the first UE, where the primary serving cell configured for sidelink communications is different from a primary serving cell configured for uplink communications for the first UE.

In some examples, the control information component 840 may be configured as or otherwise support a means for receiving, from the base station via a first CC, control information indicating a set of resources for transmitting the one or more sidelink messages, where transmitting the feedback report to the base station includes transmitting the feedback report via the first CC.

In some examples, the control information component 840 may be configured as or otherwise support a means for receiving, from the base station via a set of CCs of the multiple CCs, control information indicating a set of resources for transmitting the one or more sidelink messages, where transmitting the feedback report to the base station includes transmitting the feedback report via the set of CCs.

In some examples, transmitting the one or more sidelink messages includes transmitting the one or more sidelink messages via a first CC of the multiple CCs. In some examples, transmitting the feedback report to the base station includes transmitting the feedback report via the first CC.

In some examples, receiving the one or more feedback messages includes receiving the one or more feedback messages associated with each of the one or more sidelink messages via a respective second CC. In some examples, transmitting the feedback report to the base station includes transmitting the feedback report via each of the respective second CCs.

In some examples, receiving the one or more feedback messages includes receiving a first feedback message via a first second CC and a second feedback message via a second CC, where the second feedback message is received later than the first feedback message. In some examples, transmitting the feedback report to the base station includes transmitting the feedback report via the second CC.

In some examples, the control information component 840 may be configured as or otherwise support a means for receiving, from the base station via a first CC, control information indicating a set of resources for an uplink transmission to the base station, where transmitting the feedback report to the base station includes transmitting the feedback report via the first CC.

In some examples, the feedback report component 835 may be configured as or otherwise support a means for multiplexing the feedback report with the uplink transmission, where transmitting the feedback report to the base station includes transmitting the multiplexed feedback report and the uplink transmission. In some examples, the set of resources for the uplink transmission includes physical uplink shared channel resources, physical uplink control channel resources, or both.

In some examples, the control information component 840 may be configured as or otherwise support a means for receiving, from the base station, control information indicating a CC for transmitting the feedback report, where transmitting the feedback report to the base station includes transmitting the feedback report via the CC indicated in the control information.

In some examples, to support transmitting the feedback report to the base station, the feedback report component 835 may be configured as or otherwise support a means for transmitting, to the base station, the feedback report associated with a CC of the multiple CCs via a respective uplink control information.

In some examples, to support transmitting the feedback report to the base station, the feedback report component 835 may be configured as or otherwise support a means for transmitting, to the base station, the feedback report associated with the multiple CCs via an uplink control information.

In some examples, the control information component 840 may be configured as or otherwise support a means for receiving, from the base station via a first CC, control information indicating a set of resources for the one or more sidelink messages transmitted via the multiple CCs, where transmitting the one or more sidelink messages is based on receiving the control information.

In some examples, the resource request component 850 may be configured as or otherwise support a means for transmitting, to the base station, a request for resources for sidelink communications, where receiving the control information is based on transmitting the request. In some examples, the multiple CCs are associated with a sidelink carrier aggregation communication scheme.

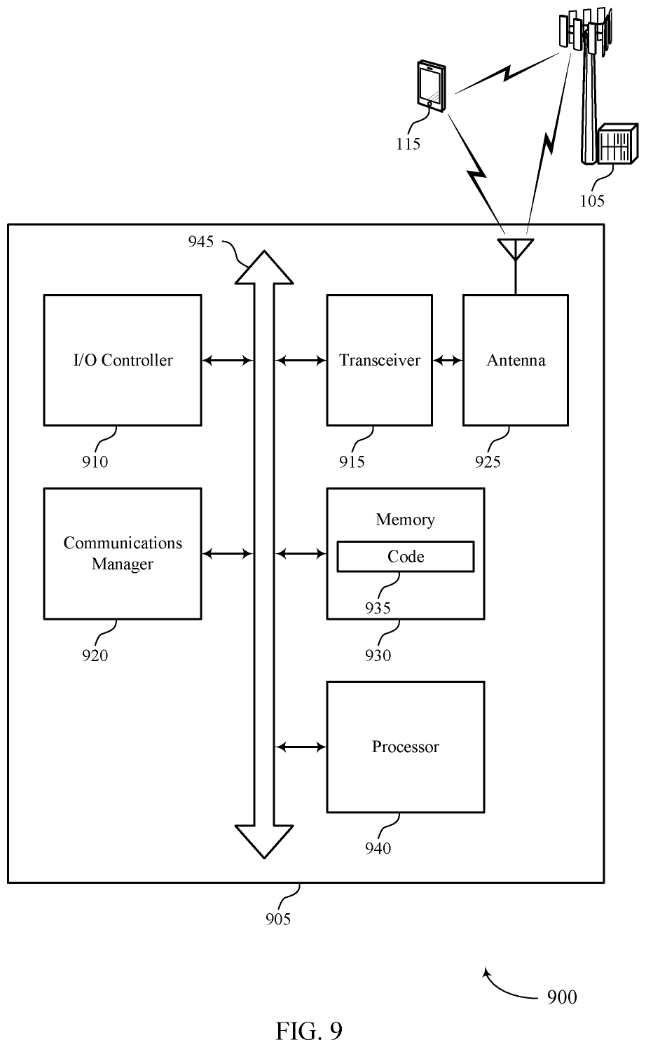

FIG. 9 shows a diagram of a system 900 including a device 905 that

supports feedback report for sidelink communications using carrier aggregation in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting feedback report for sidelink communications using carrier aggregation). For example, the device 905 or a component of the device 905 may include a processor 940 and memory 930 coupled with the processor 940, the processor 940 and memory 930 configured to perform various functions described herein.

The communications manager 920 may support wireless communication at a first UE in accordance with examples as disclosed herein. For example, the communications manager 920 may be configured as or otherwise support a means for transmitting one or more sidelink messages via multiple CCs configured for sidelink communications for the first UE. The communications manager 920 may be configured as or otherwise support a means for receiving, from a second UE, one or more feedback messages associated with the one or more sidelink messages. The communications manager 920 may be configured as or otherwise support a means for transmitting, to a base station, a feedback report that indicates feedback associated with at least one of the one or more sidelink messages, the feedback report based on the one or more feedback messages received from the second UE.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of feedback report for sidelink communications using carrier aggregation as described herein, or the processor 940 and the memory 930 may be otherwise configured to perform or support such operations.

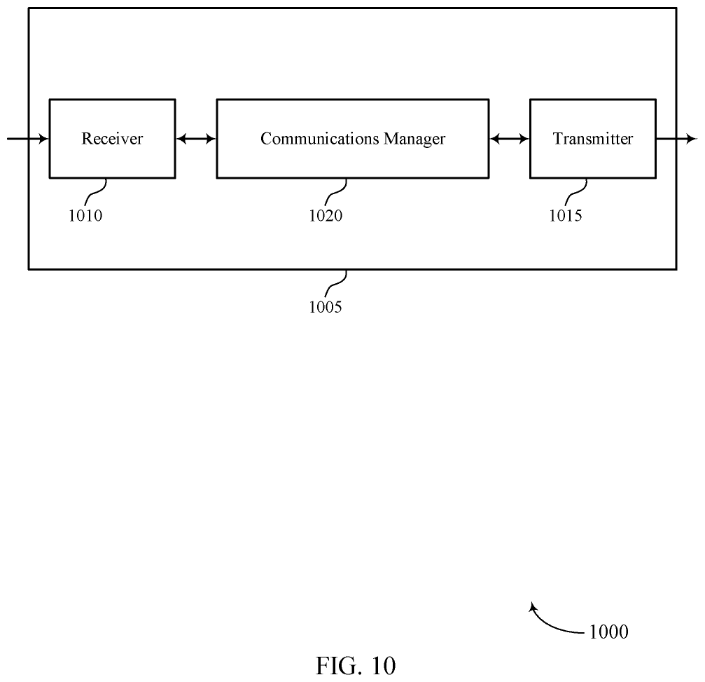

FIG. 10 shows a block diagram 1000 of a device 1005 that supports

feedback report for sidelink communications using carrier aggregation in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to feedback report for sidelink communications using carrier aggregation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to feedback report for sidelink communications using carrier aggregation). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of feedback report for sidelink communications using carrier aggregation as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

For example, the communications manager 1020 may be configured as or otherwise support a means for receiving, from a UE, a request for resources for one or more sidelink messages to be transmitted by the UE via multiple CCs. The communications manager 1020 may be configured as or otherwise support a means for transmitting, to the UE and in response to the request, control information indicating a set of resources for the one or more sidelink messages to be transmitted by the UE via the multiple CCs. The communications manager 1020 may be configured as or otherwise support a means for receiving, from the UE, a feedback report that indicates feedback associated with at least one of the one or more sidelink messages transmitted by the UE.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, and reduced power consumption.

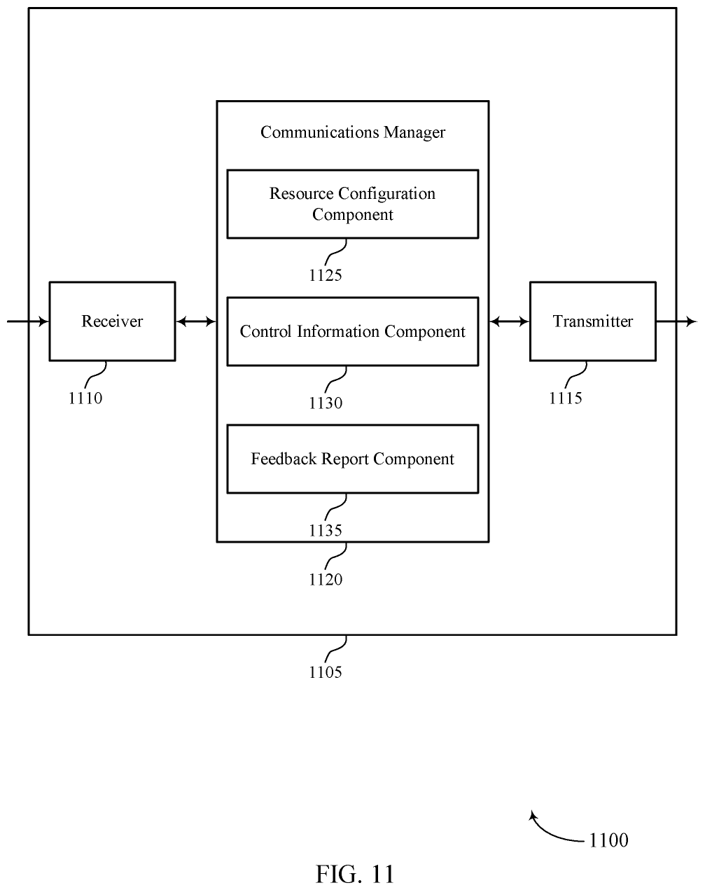

FIG. 11 shows a block diagram 1100 of a device 1105 that supports feedback report for sidelink communications using carrier aggregation in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to feedback report for sidelink communications using carrier aggregation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to feedback report for sidelink communications using carrier aggregation). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of feedback report for sidelink communications using carrier aggregation as described herein. For example, the communications manager 1120 may include a resource configuration component 1125, a control information component 1130, a feedback report component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The resource configuration component 1125 may be configured as or otherwise support a means for receiving, from a UE, a request for resources for one or more sidelink messages to be transmitted by the UE via multiple CCs. The control information component 1130 may be configured as or otherwise support a means for transmitting, to the UE and in response to the request, control information indicating a set of resources for the one or more sidelink messages to be transmitted by the UE via the multiple CCs. The feedback report component 1135 may be configured as or otherwise support a means for receiving, from the UE, a feedback report that indicates feedback associated with at least one of the one or more sidelink messages transmitted by the UE.

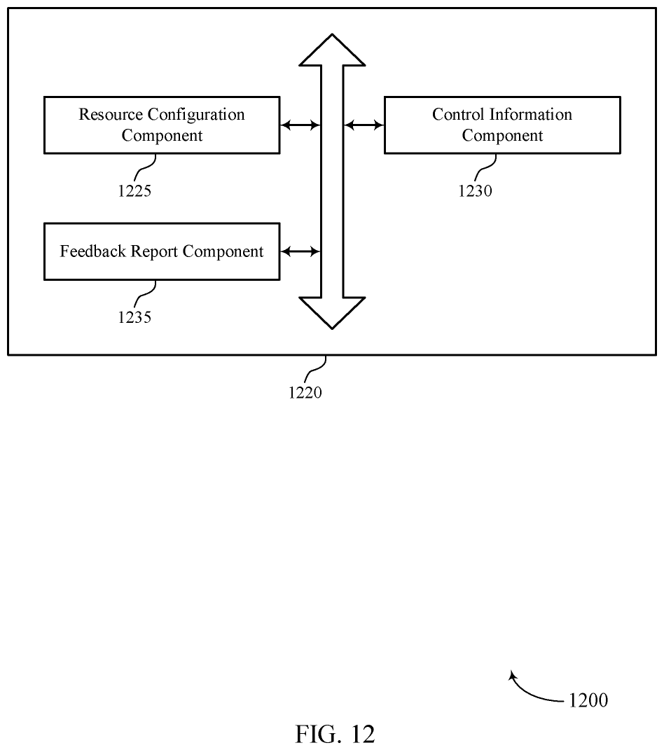

FIG. 12 shows a block diagram 1200 of a communications manager 1220 that supports feedback report for sidelink communications using carrier aggregation in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of feedback report for sidelink communications using carrier aggregation as described herein. For example, the communications manager 1220 may include a resource configuration component 1225, a control information component 1230, a feedback report component 1235, or any combination thereof. Each of these components may communicate, directly or indirectly, with one another (e.g., via one or more buses).

The resource configuration component 1225 may be configured as or otherwise support a means for receiving, from a UE, a request for resources for one or more sidelink messages to be transmitted by the UE via multiple CCs. The control information component 1230 may be configured as or otherwise support a means for transmitting, to the UE and in response to the request, control information indicating a set of resources for the one or more sidelink messages to be transmitted by the UE via the multiple CCs. The feedback report component 1235 may be configured as or otherwise support a means for receiving, from the UE, a feedback report that indicates feedback associated with at least one of the one or more sidelink messages transmitted by the UE.

In some examples, to support receiving the feedback report from the UE, the feedback report component 1235 may be configured as or otherwise support a means for receiving the feedback report via a CC associated with a primary serving cell configured for uplink communications for the UE.

In some examples, to support receiving the feedback report from the UE, the feedback report component 1235 may be configured as or otherwise support a means for receiving the feedback report via a CC associated with a primary serving cell configured for sidelink communications for the UE, where the primary serving cell configured for sidelink communications is different from a primary serving cell configured for uplink communications for the UE.

In some examples, the control information component 1230 may be configured as or otherwise support a means for transmitting the control information includes transmitting, via a first CC, the control information indicating the set of resources for the one or more sidelink messages. In some examples, the feedback report component 1235 may be configured as or otherwise support a means for receiving the feedback report from the UE includes receiving the feedback report via the first CC.

In some examples, the control information component 1230 may be configured as or otherwise support a means for transmitting the control information includes transmitting, via a set of CCs of the multiple CCs, the control information indicating the set of resources for the one or more sidelink messages. In some examples, the feedback report component 1235 may be configured as or otherwise support a means for receiving the feedback report from the UE includes receiving the feedback report via the set of CCs.

In some examples, to support receiving the feedback report from the UE, the feedback report component 1235 may be configured as or otherwise support a means for receiving the feedback report via a first CC of the multiple CCs, where the one or more sidelink messages are to be transmitted via the first CC.

In some examples, to support receiving the feedback report from the UE, the feedback report component 1235 may be configured as or otherwise support a means for receiving the feedback report via a respective CC associated with each of the one or more sidelink messages.

In some examples, transmitting the control information includes transmitting, via a first CC, the control information indicating the set of resources for an uplink transmission to the base station. In some examples, receiving the feedback report from the UE includes receiving the feedback report via the first CC. In some examples, the set of resources for the uplink transmission includes physical uplink shared channel resources, physical uplink control channel resources, or both.

In some examples, to support transmitting the control information, the control information component 1230 may be configured as or otherwise support a means for transmitting the control information indicating a CC for transmitting the feedback report, where receiving the feedback report includes receiving the feedback report via the CC indicated in the control information.

In some examples, to support receiving the feedback report from the UE, the feedback report component 1235 may be configured as or otherwise support a means for receiving, via a respective uplink control information, the feedback report associated with a CC of the multiple CCs.

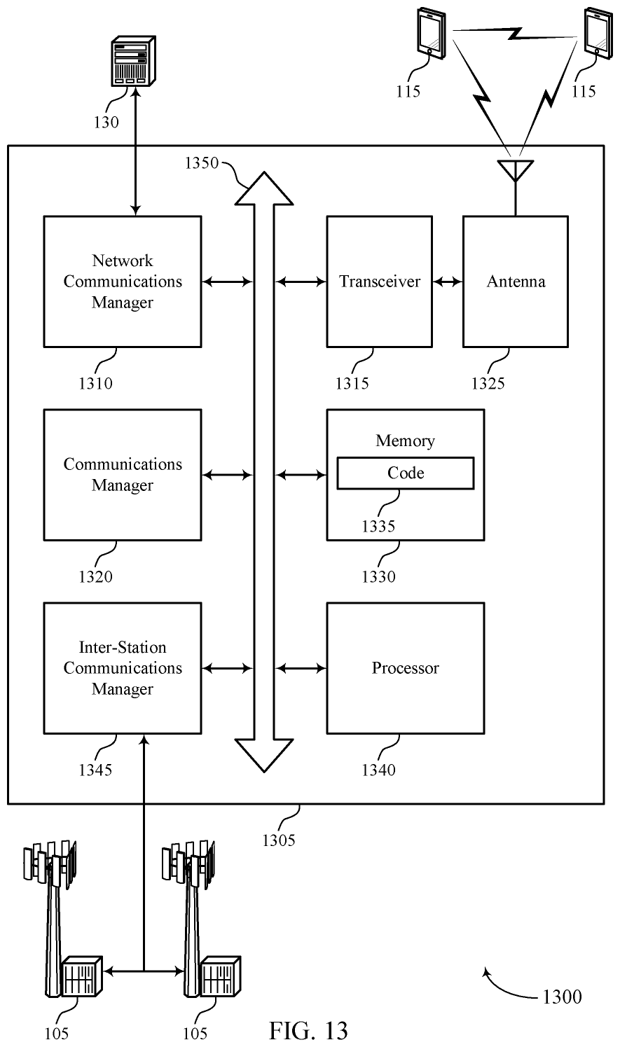

FIG. 13 shows a diagram of a system 1300 including a device 1305 that supports feedback report for sidelink communications using carrier aggregation in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-e executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting feedback report for sidelink communications using carrier aggregation). For example, the device 1305 or a component of the device 1305 may include a processor 1340 and memory 1330 coupled with the processor 1340, the processor 1340 and memory 1330 configured to perform various functions described herein.

The inter-station communications manager 1345 may manage

communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

For example, the communications manager 1320 may be configured as or otherwise support a means for receiving, from a UE, a request for resources for one or more sidelink messages to be transmitted by the UE via multiple CCs. The communications manager 1320 may be configured as or otherwise support a means for transmitting, to the UE and in response to the request, control information indicating a set of resources for the one or more sidelink messages to be transmitted by the UE via the multiple CCs. The communications manager 1320 may be configured as or otherwise support a means for receiving, from the UE, a feedback report that indicates feedback associated with at least one of the one or more sidelink messages transmitted by the UE.

By including or configuring the communications manager 1320 in accordance with examples as described herein, the device 1305 may support techniques for improved communication reliability, reduced latency, improved user experience related to reduced processing, and improved coordination between devices.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of feedback report for sidelink communications using carrier aggregation as described herein, or the processor 1340 and the memory 1330 may be otherwise configured to perform or support such operations.

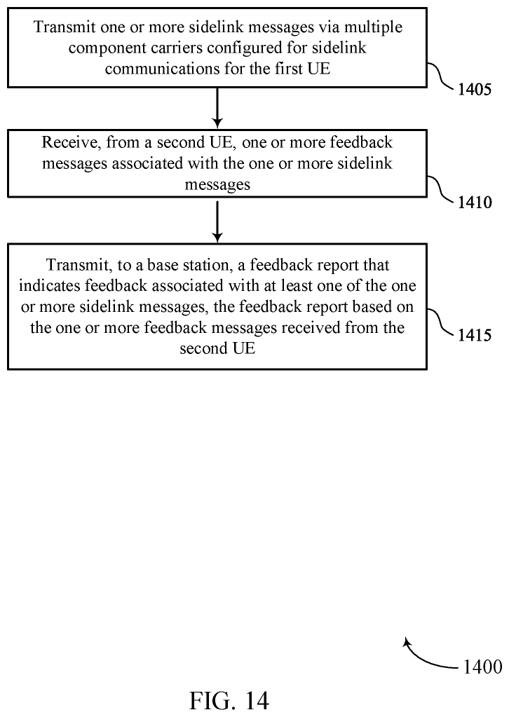

FIG. 14 shows a flowchart illustrating a method 1400 that supports feedback report for sidelink communications using carrier aggregation in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include transmitting one or more sidelink messages via multiple CCs configured for sidelink communications for the first UE. The operations of 1405 may be performed in accordance with examples as disclosed herein. In some examples, aspects of the operations of 1405 may be performed by a sidelink component 825 as described with reference to FIG. 8.

At 1410, the method may include receiving, from a second UE, one or more feedback messages associated with the one or more sidelink messages. The operations of 1410 may be performed in accordance with examples as disclosed herein. In some examples, aspects of the operations of 1410 may be performed by a feedback message component 830 as described with reference to FIG. 8.

At 1415, the method may include transmitting, to a base station, a feedback report that indicates feedback associated with at least one of the one or more sidelink messages, the feedback report based on the one or more feedback messages received from the second UE. The operations of 1415 may be performed in accordance with examples as disclosed herein. In some examples, aspects of the operations of 1415 may be performed by a feedback report component 835 as described with reference to FIG. 8.

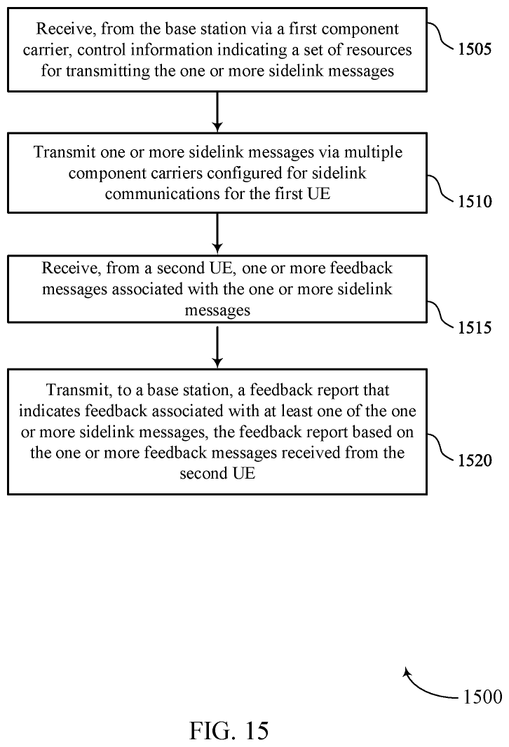

FIG. 15 shows a flowchart illustrating a method 1500 that supports feedback report for sidelink communications using carrier aggregation in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from the base station via a first CC, control information indicating a set of resources for transmitting the one or more sidelink messages. The operations of 1505 may be performed in accordance with examples as disclosed herein. In some examples, aspects of the operations of 1505 may be performed by a control information component 840 as described with reference to FIG. 8.

At 1510, the method may include transmitting one or more sidelink messages via multiple CCs configured for sidelink communications for the first UE. The operations of 1510 may be performed in accordance with examples as disclosed herein. In some examples, aspects of the operations of 1510 may be performed by a sidelink component 825 as described with reference to FIG. 8.

At 1515, the method may include receiving, from a second UE, one or more feedback messages associated with the one or more sidelink messages. The operations of 1515 may be performed in accordance with examples as disclosed herein. In some examples, aspects of the operations of 1515 may be performed by a feedback message component 830 as described with reference to FIG. 8.

At 1520, the method may include transmitting, to a base station, a feedback report that indicates feedback associated with at least one of the one or more sidelink messages, the feedback report based on the one or more feedback messages received from the second UE. In some examples, transmitting the feedback report to the base station includes transmitting the feedback report via the first CC. The operations of 1520 may be performed in accordance with examples as disclosed herein. In some examples, aspects of the operations of 1520 may be performed by a feedback report component 835 as described with reference to FIG. 8.

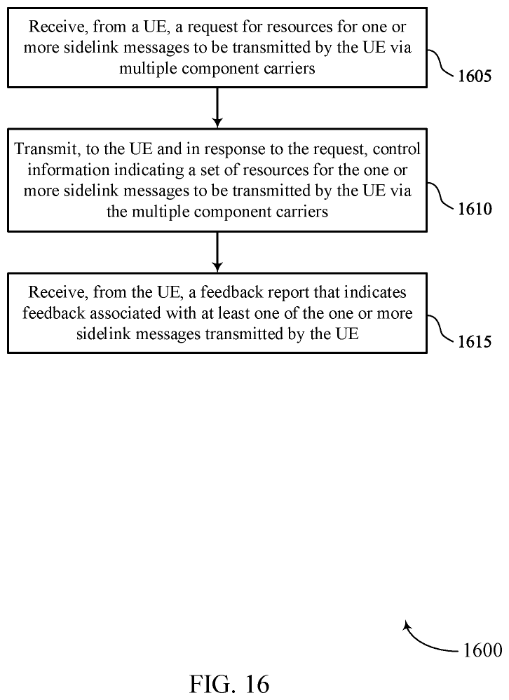

FIG. 16 shows a flowchart illustrating a method 1600 that supports feedback report for sidelink communications using carrier aggregation in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include receiving, from a UE, a request for resources for one or more sidelink messages to be transmitted by the UE via multiple CCs. The operations of 1605 may be performed in accordance with examples as disclosed herein. In some examples, aspects of the operations of 1605 may be performed by a resource configuration component 1225 as described with reference to FIG. 12.

At 1610, the method may include transmitting, to the UE and in response to the request, control information indicating a set of resources for the one or more sidelink messages to be transmitted by the UE via the multiple CCs. The operations of 1610 may be performed in accordance with examples as disclosed herein. In some examples, aspects of the operations of 1610 may be performed by a control information component 1230 as described with reference to FIG. 12.

At 1615, the method may include receiving, from the UE, a feedback report that indicates feedback associated with at least one of the one or more sidelink messages transmitted by the UE. The operations of 1615 may be performed in accordance with examples as disclosed herein. In some examples, aspects of the operations of 1615 may be performed by a feedback report component 1235 as described with reference to FIG. 12.

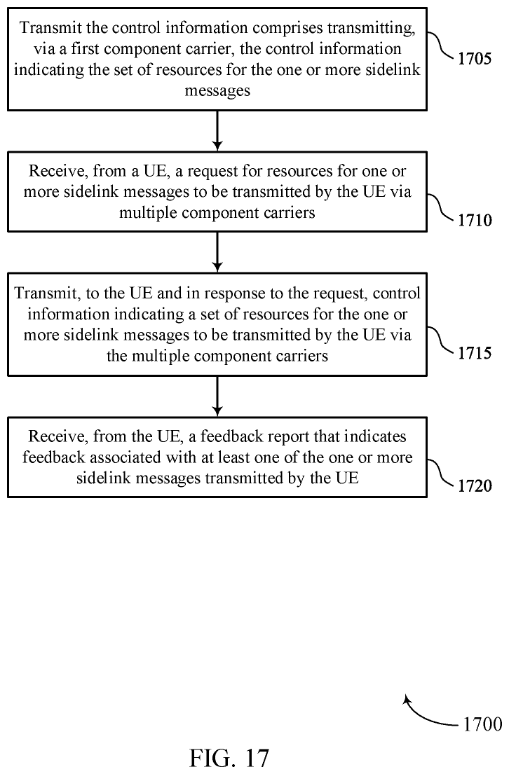

FIG. 17 shows a flowchart illustrating a method 1700 that supports feedback report for sidelink communications using carrier aggregation in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include transmitting the control information includes transmitting, via a first CC, the control information indicating the set of resources for the one or more sidelink messages. The operations of 1705 may be performed in accordance with examples as disclosed herein. In some examples, aspects of the operations of 1705 may be performed by a control information component 1230 as described with reference to FIG. 12.

At 1710, the method may include receiving, from a UE, a request for resources for one or more sidelink messages to be transmitted by the UE via multiple CCs. The operations of 1710 may be performed in accordance with examples as disclosed herein. In some examples, aspects of the operations of 1710 may be performed by a resource configuration component 1225 as described with reference to FIG. 12.

At 1715, the method may include transmitting, to the UE and in response to the request, control information indicating a set of resources for the one or more sidelink messages to be transmitted by the UE via the multiple CCs. The operations of 1715 may be performed in accordance with examples as disclosed herein. In some examples, aspects of the operations of 1715 may be performed by a control information component 1230 as described with reference to FIG. 12.

At 1720, the method may include receiving, from the UE, a feedback report that indicates feedback associated with at least one of the one or more sidelink messages transmitted by the UE. In some cases, the method may include receiving, from the UE, the feedback report via the first CC. The operations of 1720 may be performed in accordance with examples as disclosed herein. In some examples, aspects of the operations of 1720 may be performed by a feedback report component 1235 as described with reference to FIG. 12.

The following provides an overview of aspects of the present disclosure:
Aspect 1: A method for wireless communication at a first UE, comprising: transmitting one or more sidelink messages via multiple component carriers configured for sidelink communications for the first UE: receiving, from a second UE, one or more feedback messages associated with the one or more sidelink messages: and transmitting, to a base station, a feedback report that indicates feedback associated with at least one of the one or more sidelink messages, the feedback report based at least in part on the one or more feedback messages received from the second UE.
Aspect 2: The method of aspect 1, wherein transmitting the feedback report to the base station comprises: transmitting the feedback report via a component carrier associated with a primary serving cell configured for uplink communications for the first UE.
Aspect 3: The method of any of aspects 1 through 2, wherein transmitting the feedback report to the base station comprises: transmitting the feedback report via a component carrier associated with a primary serving cell configured for sidelink communications for the first UE, wherein the primary serving cell configured for sidelink communications is different from a primary serving cell configured for uplink communications for the first UE.
Aspect 4: The method of any of aspects 1 through 3, further comprising: receiving, from the base station via a first component carrier, control information indicating a set of resources for transmitting the one or more sidelink messages, wherein transmitting the feedback report to the base station comprises transmitting the feedback report via the first component carrier.
Aspect 5: The method of any of aspects 1 through 4, further comprising: receiving, from the base station via a set of component carriers of the multiple component carriers, control information indicating a set of resources for transmitting the one or more sidelink messages, wherein transmitting the feedback report to the base station comprises transmitting the feedback report via the set of component carriers.
Aspect 6: The method of any of aspects 1 through 5, wherein transmitting the one or more sidelink messages comprises transmitting the one or more sidelink messages via a first component carrier of the multiple component carriers: and transmitting the feedback report to the base station comprises transmitting the feedback report via the first component carrier.
Aspect 7: The method of any of aspects 1 through 6, wherein receiving the one or more feedback messages comprises receiving the one or more feedback messages associated with each of the one or more sidelink messages via a respective second component carrier: and transmitting the feedback report to the base station comprises transmitting the feedback report via each of the respective second component carriers.
Aspect 8: The method of any of aspects 1 through 7, wherein receiving the one or more feedback messages comprises receiving a first feedback message via a first second component carrier and a second feedback message via a second component carrier, wherein the second feedback message is received later than the first feedback message: and transmitting the feedback report to the base station comprises transmitting the feedback report via the second component carrier.
Aspect 9: The method of any of aspects 1 through 8, further comprising: receiving, from the base station via a first component carrier, control information indicating a set of resources for an uplink transmission to the base station, wherein transmitting the feedback report to the base station comprises transmitting the feedback report via the first component carrier.
Aspect 10: The method of aspect 9, further comprising: multiplexing the feedback report with the uplink transmission, wherein transmitting the feedback report to the base station comprises transmitting the multiplexed feedback report and the uplink transmission.
Aspect 11: The method of any of aspects 9 through 10, wherein the set of resources for the uplink transmission comprises physical uplink shared channel resources, physical uplink control channel resources, or both.
Aspect 12: The method of any of aspects 1 through 11, further comprising: receiving, from the base station, control information indicating a component carrier for transmitting the feedback report, wherein transmitting the feedback report to the base station comprises transmitting the feedback report via the component carrier indicated in the control information.
Aspect 13: The method of any of aspects 1 through 12, wherein transmitting the feedback report to the base station comprises: transmitting, to the base station, the feedback report associated with a component carrier of the multiple component carriers via a respective uplink control information.
Aspect 14: The method of any of aspects 1 through 13, wherein transmitting the feedback report to the base station comprises: transmitting, to the base station, the feedback report associated with the multiple component carriers via an uplink control information.
Aspect 15: The method of any of aspects 1 through 14, further comprising: receiving, from the base station via a first component carrier, control information indicating a set of resources for the one or more sidelink messages transmitted via the multiple component carriers, wherein transmitting the one or more sidelink messages is based at least in part on receiving the control information.
Aspect 16: The method of aspect 15, further comprising: transmitting, to the base station, a request for resources for sidelink communications, wherein receiving the control information is based at least in part on transmitting the request.
Aspect 17: The method of any of aspects 1 through 16, wherein the multiple component carriers are associated with a sidelink carrier aggregation communication scheme.
Aspect 18: A method of wireless communications at a base station, the method comprising: receiving, from a UE, a request for resources for one or more sidelink messages to be transmitted by the UE via multiple component carriers: transmitting, to the UE and in response to the request, control information indicating a set of resources for the one or more sidelink messages to be transmitted by the UE via the multiple component carriers: and receiving, from the UE, a feedback report that indicates feedback associated with at least one of the one or more sidelink messages transmitted by the UE.
Aspect 19: The method of aspect 18, wherein receiving the feedback report from the UE comprises: receiving the feedback report via a component carrier associated with a primary serving cell configured for uplink communications for the UE
Aspect 20: The method of any of aspects 18 through 19, wherein receiving the feedback report from the UE comprises: receiving the feedback report via a component carrier associated with a primary serving cell configured for sidelink communications for the UE, wherein the primary serving cell configured for sidelink communications is different from a primary serving cell configured for uplink communications for the UE.
Aspect 21: The method of any of aspects 18 through 20, further comprising: transmitting the control information comprises transmitting, via a first component carrier, the control information indicating the set of resources for the one or more sidelink messages; and receiving the feedback report from the UE comprises receiving the feedback report via the first component carrier.
Aspect 22: The method of any of aspects 18 through 21, further comprising: transmitting the control information comprises transmitting, via a set of component carriers of the multiple component carriers, the control information indicating the set of resources for the one or more sidelink messages: and receiving the feedback report from the UE comprises receiving the feedback report via the set of component carriers.
Aspect 23: The method of any of aspects 18 through 22, wherein receiving the feedback report from the UE comprises: receiving the feedback report via a first component carrier of the multiple component carriers, wherein the one or more sidelink messages are to be transmitted via the first component carrier.
Aspect 24: The method of any of aspects 18 through 23, wherein receiving the feedback report from the UE comprises: receiving the feedback report via a respective component carrier associated with each of the one or more sidelink messages.
Aspect 25: The method of any of aspects 18 through 24, wherein transmitting the control information comprises transmitting, via a first component carrier, the control information indicating the set of resources for an uplink transmission to the base station: and receiving the feedback report from the UE comprises receiving the feedback report via the first component carrier.
Aspect 26: The method of aspect 25, wherein the set of resources for the uplink transmission comprises physical uplink shared channel resources, physical uplink control channel resources, or both.
Aspect 27: The method of any of aspects 18 through 26, wherein transmitting the control information comprises: transmitting the control information indicating a component carrier for transmitting the feedback report, wherein receiving the feedback report comprises receiving the feedback report via the component carrier indicated in the control information.
Aspect 28: The method of any of aspects 18 through 27, wherein receiving the feedback report from the UE comprises: receiving, via a respective uplink control information, the feedback report associated with a component carrier of the multiple component carriers.
Aspect 29: An apparatus for wireless communication at a first UE, comprising a processor; memory coupled with the processor; and instructions stored in the memory and executable by the processor to cause the apparatus to perform a method of any of aspects 1 through 17.
Aspect 30: An apparatus for wireless communication at a first UE, comprising at least one means for performing a method of any of aspects 1 through 17.
Aspect 31: A non-transitory computer-readable medium storing code for wireless communication at a first UE, the code comprising instructions executable by a processor to perform a method of any of aspects 1 through 17.
Aspect 32: An apparatus comprising a processor; memory coupled with the processor; and instructions stored in the memory and executable by the processor to cause the apparatus to perform a method of any of aspects 18 through 28.
Aspect 33: An apparatus comprising at least one means for performing a method of any of aspects 18 through 28.
Aspect 34: A non-transitory computer-readable medium storing code the code comprising instructions executable by a processor to perform a method of any of aspects 18 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a first user equipment (UE), comprising:
transmitting one or more sidelink messages via multiple component carriers configured for sidelink communications for the first UE;
receiving, from a second UE, one or more feedback messages associated with the one or more sidelink messages; and
transmitting, to a base station, a feedback report that indicates feedback associated with at least one of the one or more sidelink messages, the feedback report based at least in part on the one or more feedback messages received from the second UE.

2. The method of claim 1, wherein transmitting the feedback report to the base station comprises:
transmitting the feedback report via a component carrier associated with a primary serving cell configured for uplink communications for the first UE.

3. The method of claim 1, wherein transmitting the feedback report to the base station comprises:
transmitting the feedback report via a component carrier associated with a primary serving cell configured for sidelink communications for the first UE, wherein the primary serving cell configured for sidelink communications is different from a primary serving cell configured for uplink communications for the first UE.

4. The method of claim 1, further comprising:
receiving, from the base station via a first component carrier, control information indicating a set of resources for transmitting the one or more sidelink messages, wherein transmitting the feedback report to the base station comprises transmitting the feedback report via the first component carrier.

5. The method of claim 1, further comprising:
receiving, from the base station via a set of component carriers of the multiple component carriers, control information indicating a set of resources for transmitting the one or more sidelink messages, wherein transmitting the feedback report to the base station comprises transmitting the feedback report via the set of component carriers.

6. The method of claim 1, wherein:
transmitting the one or more sidelink messages comprises transmitting the one or more sidelink messages via a first component carrier of the multiple component carriers; and
transmitting the feedback report to the base station comprises transmitting the feedback report via the first component carrier.

7. The method of claim 1, wherein:
receiving the one or more feedback messages comprises receiving the one or more feedback messages associated with each of the one or more sidelink messages via a respective second component carrier; and
transmitting the feedback report to the base station comprises transmitting the feedback report via each of the respective second component carriers.

8. The method of claim 1, wherein:
receiving the one or more feedback messages comprises receiving a first feedback message via a first second component carrier and a second feedback message via a second component carrier, wherein the second feedback message is received later than the first feedback message; and
transmitting the feedback report to the base station comprises transmitting the feedback report via the second component carrier.

9. The method of claim 1, further comprising:
receiving, from the base station via a first component carrier, control information indicating a set of resources for an uplink transmission to the base station, wherein transmitting the feedback report to the base station comprises transmitting the feedback report via the first component carrier.

10. The method of claim 9, further comprising:
multiplexing the feedback report with the uplink transmission, wherein transmitting the feedback report to the base station comprises transmitting the multiplexed feedback report and the uplink transmission.

11. The method of claim 9, wherein the set of resources for the uplink transmission comprises physical uplink shared channel resources, physical uplink control channel resources, or both.

12. The method of claim 1, further comprising:
receiving, from the base station, control information indicating a component carrier for transmitting the feedback report, wherein transmitting the feedback report to the base station comprises transmitting the feedback report via the component carrier indicated in the control information.

13. The method of claim 1, wherein transmitting the feedback report to the base station comprises:
transmitting, to the base station, the feedback report associated with a component carrier of the multiple component carriers via a respective uplink control information.

14. The method of claim 1, wherein transmitting the feedback report to the base station comprises:
transmitting, to the base station, the feedback report associated with the multiple component carriers via an uplink control information.

15. The method of claim 1, further comprising:
receiving, from the base station via a first component carrier, control information indicating a set of resources for the one or more sidelink messages transmitted via the multiple component carriers, wherein transmitting the one or more sidelink messages is based at least in part on receiving the control information.

16. The method of claim 15, further comprising:
transmitting, to the base station, a request for resources for sidelink communications, wherein receiving the control information is based at least in part on transmitting the request.

17. The method of claim 1, wherein the multiple component carriers are associated with a sidelink carrier aggregation communication scheme.

18. A method of wireless communications at a base station, the method comprising:
receiving, from a user equipment (UE), a request for resources for one or more sidelink messages to be transmitted by the UE via multiple component carriers;
transmitting, to the UE and in response to the request, control information indicating a set of resources for the one or more sidelink messages to be transmitted by the UE via the multiple component carriers; and
receiving, from the UE, a feedback report that indicates feedback associated with at least one of the one or more sidelink messages transmitted by the UE.

19. The method of claim 18, wherein receiving the feedback report from the UE comprises:
receiving the feedback report via a component carrier associated with a primary serving cell configured for uplink communications for the UE.

20. The method of claim 18, wherein receiving the feedback report from the UE comprises:
receiving the feedback report via a component carrier associated with a primary serving cell configured for sidelink communications for the UE, wherein the primary serving cell configured for sidelink communications is different from a primary serving cell configured for uplink communications for the UE.

21. The method of claim 18, further comprising:
transmitting the control information comprises transmitting, via a first component carrier, the control information indicating the set of resources for the one or more sidelink messages; and
receiving the feedback report from the UE comprises receiving the feedback report via the first component carrier.

22. The method of claim 18, further comprising:
transmitting the control information comprises transmitting, via a set of component carriers of the multiple component carriers, the control information indicating the set of resources for the one or more sidelink messages; and
receiving the feedback report from the UE comprises receiving the feedback report via the set of component carriers.

23. The method of claim 18, wherein receiving the feedback report from the UE comprises:
receiving the feedback report via a first component carrier of the multiple component carriers, wherein the one or more sidelink messages are to be transmitted via the first component carrier.

24. The method of claim 18, wherein receiving the feedback report from the UE comprises:
receiving the feedback report via a respective component carrier associated with each of the one or more sidelink messages.

25. The method of claim 18, wherein:
transmitting the control information comprises transmitting, via a first component carrier, the control information indicating the set of resources for an uplink transmission to the base station; and
receiving the feedback report from the UE comprises receiving the feedback report via the first component carrier.

26. The method of claim 25, wherein the set of resources for the uplink transmission comprises physical uplink shared channel resources, physical uplink control channel resources, or both.

27. The method of claim 18, wherein transmitting the control information comprises:
transmitting the control information indicating a component carrier for transmitting the feedback report, wherein receiving the feedback report comprises receiving the feedback report via the component carrier indicated in the control information.

28. The method of claim 18, wherein receiving the feedback report from the UE comprises:
receiving, via a respective uplink control information, the feedback report associated with a component carrier of the multiple component carriers.

29. An apparatus for wireless communication at a first user equipment (UE), comprising:
a processor,
memory coupled with the processor; and
instructions stored in the memory and executable by the processor to cause the apparatus to:
transmit one or more sidelink messages via multiple component carriers configured for sidelink communications for the first UE;
receive, from a second UE, one or more feedback messages associated with the one or more sidelink messages; and
transmit, to a base station, a feedback report that indicates feedback associated with at least one of the one or more sidelink messages, the feedback report based at least in part on the one or more feedback messages received from the second UE.

30. An apparatus for wireless communication at a base station, comprising:
a processor, memory coupled with the processor; and
instructions stored in the memory and executable by the processor to cause the apparatus to:
receive, from a user equipment (UE), a request for resources for one or more sidelink messages to be transmitted by the UE via multiple component carriers;
transmit, to the UE and in response to the request, control information indicating a set of resources for the one or more sidelink messages to be transmitted by the UE via the multiple component carriers; and
receive, from the UE, a feedback report that indicates feedback associated with at least one of the one or more sidelink messages transmitted by the UE.
